(19) United States
(12) Patent Application Publication
(10) Pub. No.: US 2014/0360777 A1
(43) Pub. Date: Dec. 11, 2014

(54) NETWORK INTERFACE DEVICE CONDUIT FITTING

(71) Applicants: Eddie Kimbrell, Dacula, GA (US); Ted Lichoulas, Simpsonville, SC (US)

(72) Inventors: Eddie Kimbrell, Dacula, GA (US); Ted Lichoulas, Simpsonville, SC (US)

(73) Assignee: AFL TELECOMMUNICATIONS LLC, Duncan, SC (US)

(21) Appl. No.: 14/130,365

(22) PCT Filed: Jul. 5, 2012
(86) PCT No.: PCT/US2012/045503

§ 371 Date: Aug. 27, 2014

Related U.S. Application Data
(60) Provisional application No. 61/504,397, filed on Jul. 5, 2011.

(51) Int. Cl. H02G 3/08

(52) U.S. Cl. CPC H02G 3/083
USPC 174/669

(57) ABSTRACT

A conduit fitting for connecting a conduit to a NID. The fitting includes a tube with an inner diameter and an outer diameter, and a flange at one end of the tube. The inner diameter is configured to provide a tight fit over a piping and the outer diameter is configured to provide a tight fit in a conduit.

### CROSS-REFERENCE TO RELATED APPLICATIONS

This application is based upon and claims the benefit of priority from U.S. Provisional Application No. 61/504,397, filed Jul. 5, 2011 in the United States Patent and Trademark Office, the disclosure of which is incorporated herein in its entirety by reference.

### BACKGROUND

1. Field

The invention is related to a means to retrofit the installed base of NIDs to accept conduit. More particularly, it relates to a conduit fitting for connecting a conduit to a NID.

2. Related Art

In the United States, telecommunications service providers run a large variety of cable types to and from network interface devices (NIDs) installed at residences. These cables include standard telecommunications twisted pair cables (CAT-3), CAT-5 copper cables, coaxial cable, and optical fiber cables. These cables are typically light duty and are susceptible to environmental and mechanical damage unless protected in a conduit. The commonly deployed NIDs, however, are not designed to accept conduit and field technicians must improvise methods to route conduit to the NIDs, or replace the installed NIDs with new enclosures designed to accept conduit.

It is an object of the invention to provide a low cost means to retrofit the installed base of NIDs to accept conduit. This may be accomplished by an inserted adapter added to the NID Cable Tie Off which is optimized to mate and seal the inbound conduit, and to penetrate the grommet without compromising sealing.

Another objective of the invention is to provide a means that allows continued usage of the installed NID base and allows the means to be installed or removed in the field.

Another objective of the invention is to provide a means that provides a sealed connection to the conduit.

### SUMMARY

Exemplary implementations of the present invention address at least the above problems and/or disadvantages and other disadvantages not described above. Also, the present invention is not required to overcome the disadvantages described above, and an exemplary implementation of the present invention may not overcome any of the problems listed above.

An embodiment of the invention is a conduit fitting with a tube with an inner diameter and an outer diameter; and a flange at one end of the tube. The inner diameter is configured to provide a tight fit over a piping, and the outer diameter is configured to provide a tight fit in a conduit.

This embodiment may also include a bushing on another end of the tube.

In this embodiment, the tube may be made of PVC.

A second embodiment of the invention is a conduit fitting with a tube with an inner diameter and a first outer diameter and a second outer diameters and a flange in the tube. The first outer diameter is configured to provide a tight fit in a conduit and the second outer diameter is smaller than said first outer diameter.

This second embodiment may include a bushing on an end of the tube.

In this embodiment, the tube may be made of PVC.

A third embodiment of the invention is a conduit fitting with a tube with a grommet portion, a piping portion and a conduit fitting end. The inner diameter of the piping portion is smaller than the inner diameter of the conduit fitting end. Also, the inner diameter of the conduit fitting end is configured to provide a tight fit around a conduit.

In this embodiment, the tube may be made of PVC.

In this embodiment, the outer diameter of the piping portion is smaller than the outer diameter of the conduit fitting end.

### BRIEF DESCRIPTION OF THE DRAWING

FIG. 1 shows an exemplary conventional NID.

FIG. 2 shows a portion of the exemplary conventional NID in FIG. 1.

FIG. 3 shows a portion of the exemplary conventional NID in FIG. 1 with the subscriber cover open.

FIG. 4 shows a cross-sectional view of an embodiment of the NID conduit fitting of the present invention.

FIG. 5 shows another view of an embodiment of the NID conduit fitting of the present invention.

FIG. 6 shows a perspective view of another embodiment of the NID conduit fitting of the present invention.

FIG. 7 shows a cross-sectional view of another embodiment of the NID conduit fitting of the present invention.

FIG. 8 shows a side view of another embodiment of the NID conduit fitting of the present invention.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, an exemplary embodiment will be described with reference to accompanying drawings.

Common NIDs deployed in the U.S. include those from AFL Telecommunications, Corning Cable Systems, Tyco, and Tii. These NIDs use an entry port with grommets and a cable tie down feature integrally formed in the NID base. When an installer run conduit to a NID, they typically will use one of two techniques. First, they will run conduit to within several inches of the NID bottom, and then run the cable up into the NID. This method is easy to implement but leaves these light duty cables vulnerable to mechanical damage. Alternatively, installers will insert the conduit directly into the NID through a field cut grommet. However, this method compromises the designed sealing capability of the grommet and allows contaminants (insects and dust, for example) to enter the NID.

The present invention provides a means to retrofit the installed base of NIDs to accept conduit. An inserted adapter is added to the NID Cable Tie Off which is optimized to mate and seal the inbound conduit, and to penetrate the grommet without compromising sealing.

The invention described in the referenced figures shows how this invention can be implemented on a 760 XL NID. This invention can be generalized to various industry standard, widely deployed NIDS.

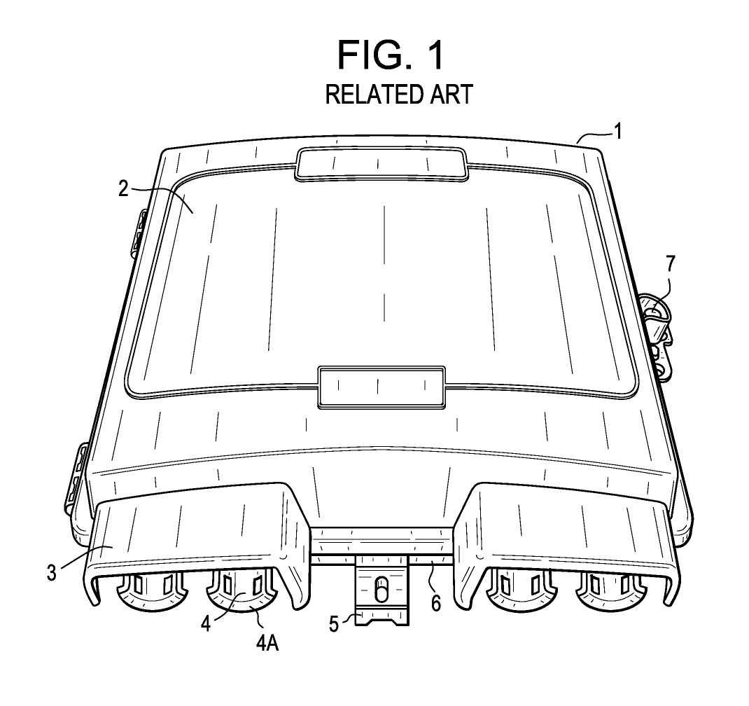

FIGS. 1-3 show views of an AFL 760XL NID 1. The figures identify some of the standard NID features. The 760XL NID is representative of commonly deployed NIDs in the U.S. The NID includes a subscriber cover 2 with rain covers 3 and security screw/latch 7. The NID also includes a base 6 with cable tie-offs 4 and a mounting foot 5.

In common practice, a copper or fiber optic cable (not shown) is routed to the bottom section of the NID 1. This cable is routed to the interior of the NID 1 through a grommet 8 and the cable is secured to a cable tie-off 4 using a tie wrap.

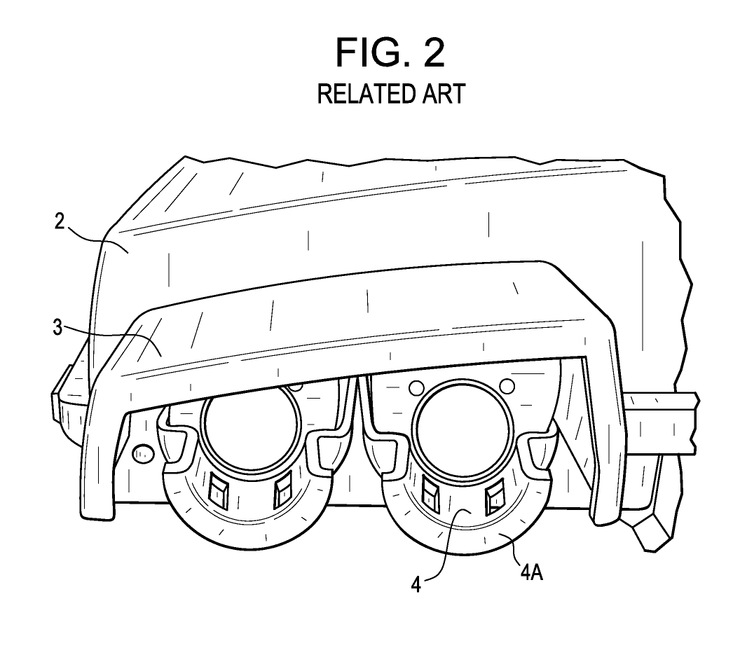

FIG. 2 shows the details of the NID cable entry portion. An opening formed by cable tie-off 4 aligns with Grommet 8. The cable-tie off 4 also has a flange 4A.

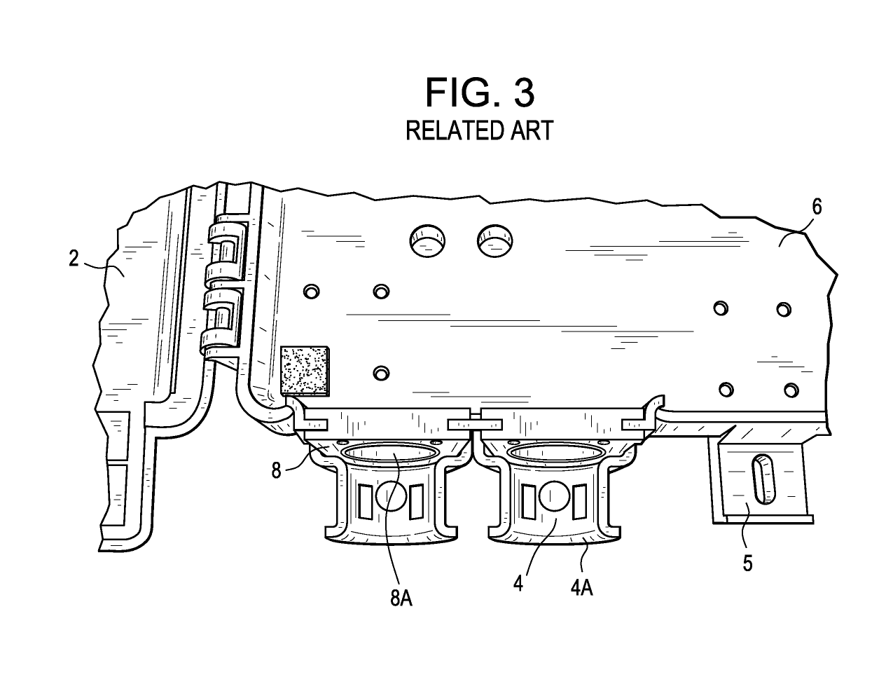

FIG. 3 shows an overhead view of the NID 1 with the subscriber cover 2 open. The figure provides a close-up view of NID cable entry port.

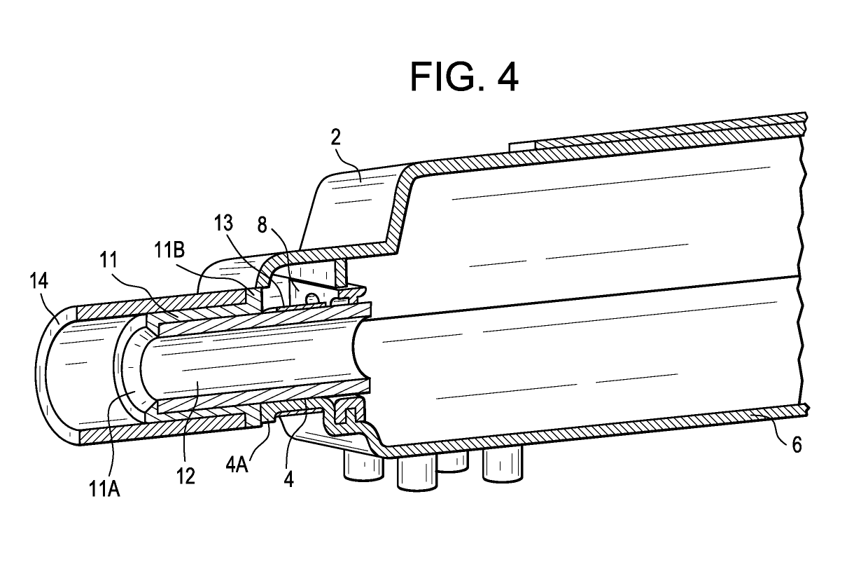

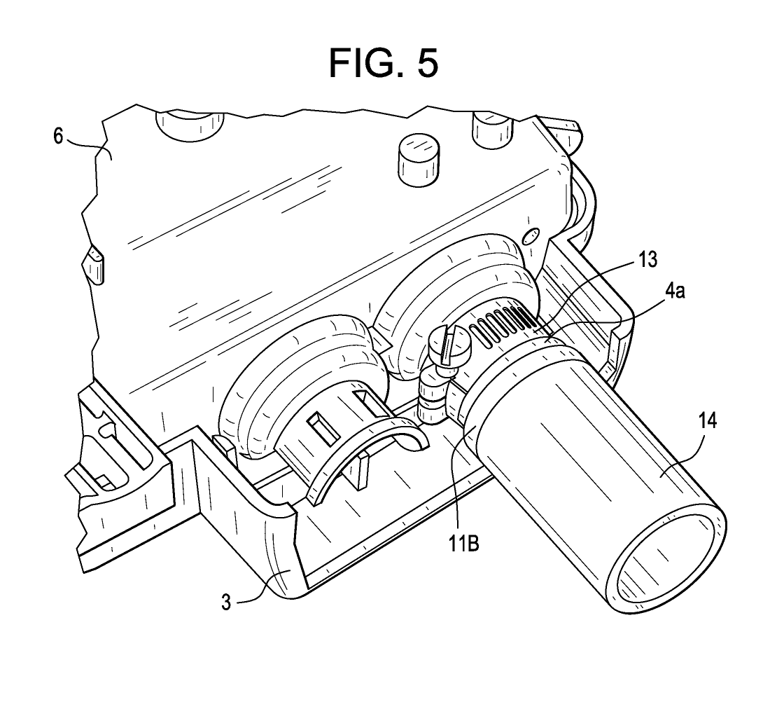

FIG. 4 shows a cross-sectional view of the NID conduit fitting 11 of the present invention. FIG. 5 is an alternate view of NID with the conduit fitting 11. The specific embodiment shown in the figures is specific to the size and dimensions of AFL's 760XL NID. However, the fitting can be easily modified and applied to many of the commonly deployed NIDs.

An explanation of the design follows. A conduit fitting 11 is shaped as a tube and may be a 1 inch by ½ inch PVC reducer is installed on a short length of standard ½ inch PVC piping 12. The end of the conduit fitting 11 has a bushing 11A that abuts the end of the piping 12. The piping 12 is inserted through the circular opening 8A of the grommet 8 and is laid into the interior semi-circle of cable tie-off 4. The tight fit with the grommet 8 provides rain and insect resistance protection. A standard hose clamp or tie wrap 13 is used to secure the piping 12 within the cable tie-off 4. When installed, the flange 11B on the conduit fitting 11 may abut the flange 4A on the cable tie-off 4. A 1-in PVC pipe conduit 14 is installed over the exterior of the conduit fitting 11 and may abut flange 11B on the conduit fitting 11. Axial movement of the conduit 14, conduit fitting 11, and piping 12 is constrained by the clamp 13, flanges 4A and 11B and bushing 11A.

The conduit fitting 11 may be made of other materials, such as polycarbonate plastic or a rubber elastomer. In the embodiment shown, which uses the conduit fitting 11 to connect a 1 inch conduit 14 to a ½ inch piping 12, the inner diameter of the conduit fitting 11 is ⅞ inch. This allows it to be pushed onto the piping 12 and so that it will form a tight fit (for example, light interference and/or press fit) on the piping 12. The outer diameter of the conduit fitting 11 is 1 inch. This allows the conduit 14 to be pushed onto the conduit fitting 11 and so that it will form a tight fit on the conduit fitting 11. In addition, the bushing 11A can be beveled to allow for easier insertion of cables. Other dimensions may be used as long as tight fits can be obtained.

In another embodiment, the conduit fitting 11, including bushing 11A and flange 11B, and piping 12 can be formed as one integral component. Thus, the conduit fitting would have a pipe with two different outer diameters. One larger diameter configured to fit in the conduit 14 and one smaller diameter configured to fit in the grommet 8.

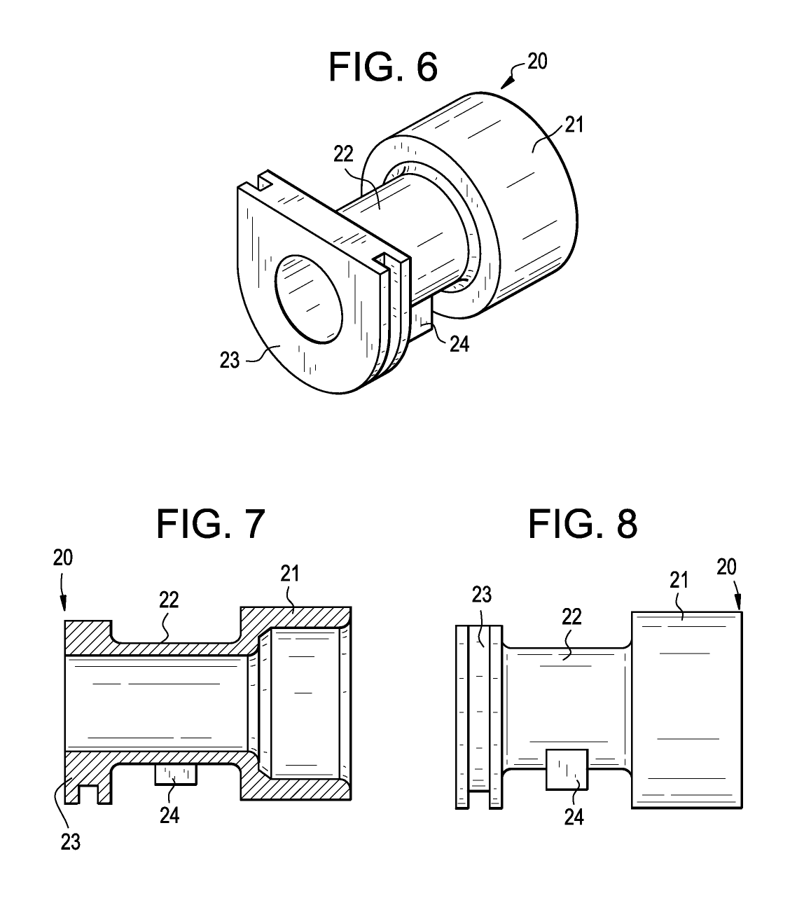

FIGS. 6 through 8 show another embodiment of a conduit fitting 20. In this embodiment, the conduit fitting is a tube with a grommet component 23, piping portion 22, and conduit fitting end 21, formed as one integral component. Conduit fitting 20 is also designed to fit in a standard NID. The grommet portion 23 would be placed in the location where grommet 8 is shown in FIG. 3. The piping portion 22 would rest in the cable tie off 4, where it can be constrained with a clamp or cable tie off. The conduit fitting 20 may also include a support 24, in the event that the outer diameter of the piping 22 is smaller than the diameter of the cable tie off 4.

The conduit fitting 20 is made of polycarbonate plastic. It may also be made of other materials, such as PVC and ABS, plastics or a rubber or elastomer. In the embodiment shown, which uses the conduit fitting 20 to connect a 1 inch conduit (not shown), the inner diameter of the piping 11 is ¾ inch and the inner diameter of the conduit end fitting 21 is 0.70 inch. This allows a conduit to be pushed into the conduit end fitting 21 so that it will form a tight fit. Other dimensions may be used as long as a tight fit can be obtained. Also in this embodiment, the outer diameter of the piping 11 is 1 inch and the outer diameter of the conduit end fitting 21 is 1.30 inch.

The concept can be generalized to fit a variety of NIDs and conduit sizes. Due to the variation in cable tie off and grommet dimensions in widely deployed NIDs, a single molded fitting can be made that is specific to each NID construction and conduit size.

Some of the benefits and advantages of the invention, include, but are not limited to: low cost; allows continued usage of installed NID base; can be field installed or removed; and provides a sealed connection to the conduit.

As mentioned above, although the exemplary embodiment described above is used with conduits and NIDs, the invention may be used in other types of applications.

What is claimed:

1. A conduit fitting comprising:
a tube with an inner diameter and an outer diameter; and
a flange at one end of said tube;
wherein said inner diameter is configured to provide a tight fit over a piping; and
wherein said outer diameter is configured to provide a tight fit in a conduit.

2. The conduit fitting of claim 1, further comprising a bushing on another end of said tube.

3. The conduit fitting of claim 1, wherein said tube comprises at least one of plastic, rubber and elastomer.

4. A conduit fitting comprising:
a tube with an inner diameter and a first outer diameter and a second outer diameters; and
a flange in said tube;
wherein said first outer diameter is configured to provide a tight fit in a conduit; and
said second outer diameter is smaller than said first outer diameter.

5. The conduit fitting of claim 4, further comprising a bushing on an end of said tube.

6. The conduit fitting of claim 4, wherein said tube comprises at least one of plastic, rubber or elastomer.

7. A conduit fitting comprising:
a tube with a grommet portion, a piping portion and a conduit fitting end;
wherein an inner diameter of said piping portion is smaller than an inner diameter of said conduit fitting end; and
wherein said inner diameter of said conduit fitting end is configured to provide a tight fit around a conduit.

8. The conduit fitting of claim 7, wherein said tube comprises at least one of plastic, rubber and elastomer.

9. The conduit fitting of claim 7, wherein said wherein an outer diameter of said piping portion is smaller than an outer diameter of said conduit fitting end.
